(19) United States
(12) Patent Application Publication
(10) Pub. No.: US 2026/0238711 A1
(43) Pub. Date: Aug. 13, 2026

(54) WEARABLE STRUCTURE

(71) Applicant: SPEED TECH CORPORATION, TAOYUAN CITY (TW)

(72) Inventors: Tsung Hua Chuang, TAOYUAN CITY (TW); Po Ching Chiang, TAOYUAN CITY (TW); Chia Sung Lin, TAOYUAN CITY (TW); Hsuan Ju Liu, TAOYUAN CITY (TW)

(21) Appl. No.: 19/341,225

(22) Filed: Sep. 26, 2025

(30) Foreign Application Priority Data
Feb. 7, 2025 (CN) 202520190593.6

(51) Int. Cl. H04M 1/04; H04B 1/3827

(52) U.S. Cl. CPC H04M 1/04; H04B 1/385

(57) ABSTRACT

A wearable structure includes a first module and a second module. The first module is provided with a first body and two first magnetic components, the first body is provided with a seat part and two groove parts, and the two groove parts and the two first magnetic components are located on the two opposite sides of the seat part. The second module is provided with a second body and two second magnetic components, the second body is provided with a body part and two hook parts, and the two hook parts and the two second magnetic components are located on the two opposite sides of the body part. The body part is mounted on the seat part of, the two hook parts are embedded in the two groove parts, and the two first magnetic components and the two second magnetic components attract each other.

### CROSS-REFERENCE TO RELATED APPLICATIONS

This application claims the priority benefit of Chinese Patent Application Serial Number 2025201905936, filed on Feb. 7, 2025 the full disclosure of which is incorporated herein by reference.

### TECHNICAL FIELD OF THE INVENTION

The present disclosure relates to the technical field of wearable accessories and particularly relates to a wearable structure.

### DESCRIPTION OF THE PRIOR ART

In current technologies, a number of handheld electronic devices have been developed so far and have also provided various functions. The handheld electronic device which most people have is a mobile phone. Taking the mobile phone as an example, the mobile phone has numerous functions such as games provided with entertainments, a pedometer assisting in exercise measurement or GPS for map navigation in addition to basic communication. However, during the use of the said mobile phone, some functions don’t need to be kept using by holding the mobile phone. If being forced to use by holding the mobile phone, these functions which don’t need to be kept using by holding the mobile phone would cause difficulty and burdens on the use thereof instead. For example, if the handheld pedometer requires using during the exercise, swinging hands naturally during the exercise is impossible, and it causes extreme inconveniences in the use of the handheld pedometer. Alternatively, if performing the navigation by the mobile phone, a user on a bike needs to hold the mobile phone to see the map by one hand, and it is a troublesome problem in the use of the navigation.

### SUMMARY

In an embodiment of the present disclosure, a wearable structure is provided and includes a first module and a second module. The first module is provided with a first body and two first magnetic components, and the first body is provided with a seat part and two groove parts. The two groove parts are respectively located on the two opposite sides of the seat part, and the two first magnetic components are respectively disposed on the two opposite sides of the seat part. The second module is provided with a second body and two second magnetic components, and the second body is provided with a body part and two hook parts. The two hook parts are respectively located on the two opposite sides of the body part, and the two second magnetic components are respectively disposed on the two opposite sides of the body part. The body part of the second body is mounted on the seat part of the first body, the two hook parts of the second body are embedded in the two groove parts of the first body, and the two first magnetic components and the two second magnetic components attract each other.

In one embodiment, the first body is provided with a first top surface and a first bottom surface opposite to the first top surface, the second body is provided with a second top surface and a second bottom surface opposite to the second top surface, and the second bottom surface of the second body is correspondingly mounted on the first top surface of the first body.

In one embodiment, the two hook parts extend from the two opposite sides of the second bottom surface in a direction far away from the second top surface, and one end of each of the two hook parts bends toward the interior of the corresponding groove part.

In one embodiment, each of the two groove parts is provided with a groove and a stable indentation, the stable indentation is located on the inner side of the groove, and the stable indentation and the groove are connected to each other. Each of the two hook parts further includes an extension body and a hook block, the extension body and the hook block are connected to each other, and the extension body extends from the second bottom surface to the corresponding groove part in the direction far away from the second top surface. The hook block extends in a direction toward the corresponding groove part and is embedded in the stable indentation.

In one embodiment, the first bottom surface of the first body is provided with two first recesses, the two first recesses are located on the two opposite sides of the seat part, and the two first magnetic components are respectively embedded in the two first recesses. The second top surface of the second body is provided with two second recesses, the two second magnetic components are respectively embedded in the two second recesses, and the positions of the two second recesses and the positions of the two first recesses correspond to each other.

In one embodiment, the first top surface of the first body has at least one first fixing structure, the second bottom surface of the second body has at least one second fixing structure, and the at least one first fixing structure and the at least one second fixing structure are fixedly connected to each other.

In one embodiment, the at least one first fixing structure is provided in two, and the two first fixing structures are located on the two opposite sides of the seat part. The at least one second fixing structure is provided in two, and the two second fixing structures are located on the two opposite sides of the body part and respectively correspond to the two first fixing structures.

In one embodiment, the first fixing structure is a recess, and the second fixing structure is a protrusion embedded in the recess.

In one embodiment, the second top surface of the second body further has a mounting structure configured to mount and fix an electronic device.

In one embodiment, the wearable structure further includes a connecting component, and there is a connecting structure on the outer side of the first body. The connecting component is fixedly connected to the connecting structure.

### BRIEF DESCRIPTION OF DRAWINGS

The accompanying drawings herein are provided to have a further understanding on the present disclosure and constitute one part of the present disclosure. The schematic embodiments of the present disclosure and the description thereof are used to explain the present disclosure instead of building inappropriate limitations on the present disclosure. In the drawings:

FIG. 1 is the schematic structural diagram of a wearable structure in one embodiment of the present disclosure;

FIG. 2 is another schematic structural diagram of the wearable structure in one embodiment of the present disclosure;

FIG. 3 is the stereoscopic cross-section diagram of the A-A’ line of FIG. 1;

FIG. 4 is the schematic exploded diagram of the wearable structure in one embodiment of the present disclosure;

FIG. 5 is another schematic exploded diagram of the wearable structure in one embodiment of the present disclosure; and

FIG. 6 is the example of the use state diagram of the wearable structure in one embodiment of the present disclosure.

### DETAILED DESCRIPTION

The multiple embodiments of the present disclosure will be disclosed by the drawings as follows, and for precise explanation, the implementation details of the present disclosure will be explained in the following paragraphs. However, it should be understood that the implementation details of the present disclosure should not be construed as the restrictions of the present disclosure. In other words, in some embodiments of the present disclosure, the implementation details of the present disclosure are not essential. In addition, for simplifying the drawings, some well-known structures and modules in the drawings are depicted by simple illustrations. In the following embodiments, the same reference numbers in different drawings represent the same or similar modules.

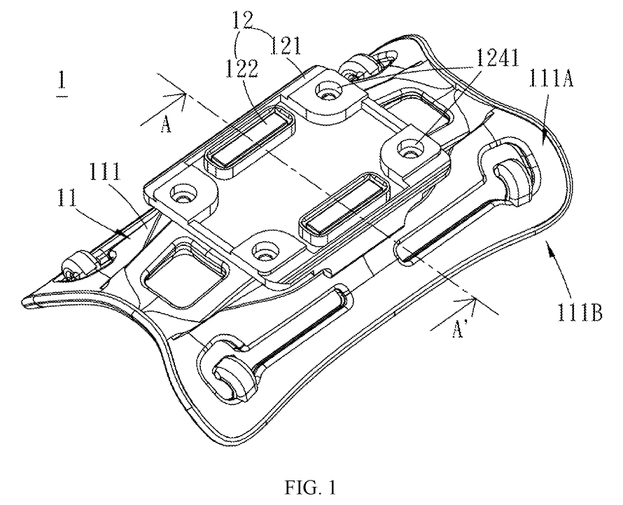

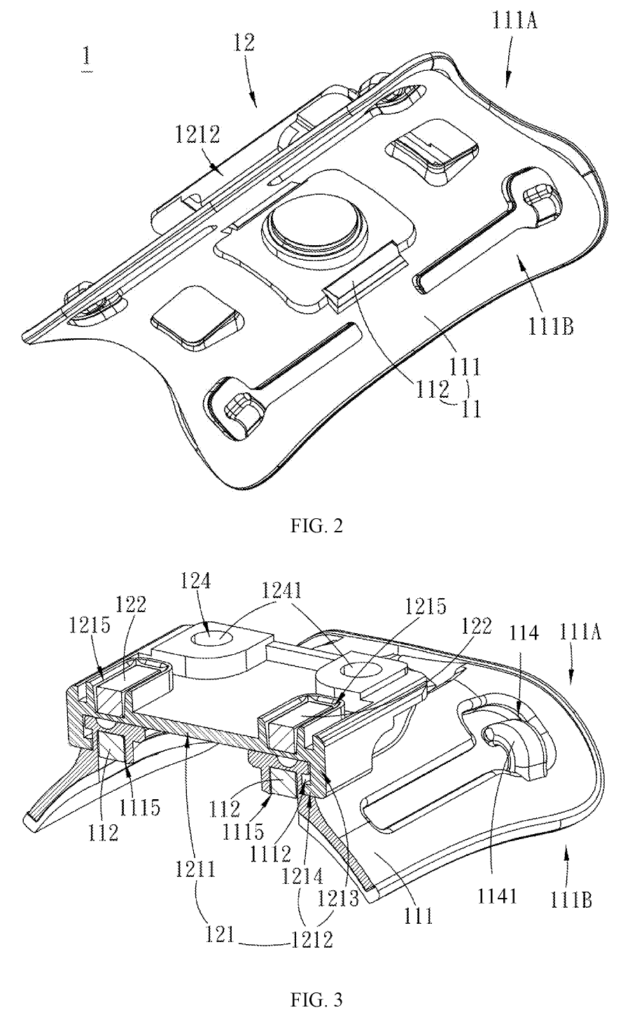

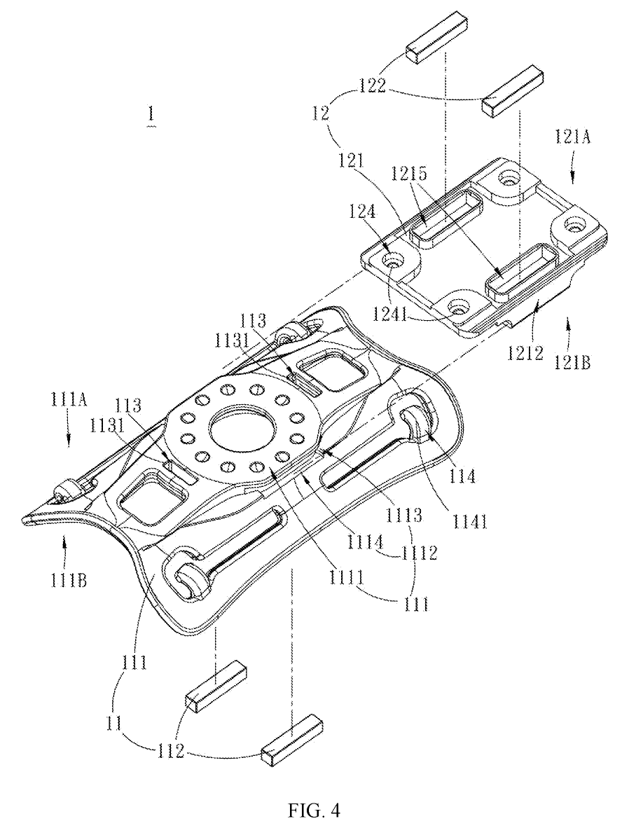

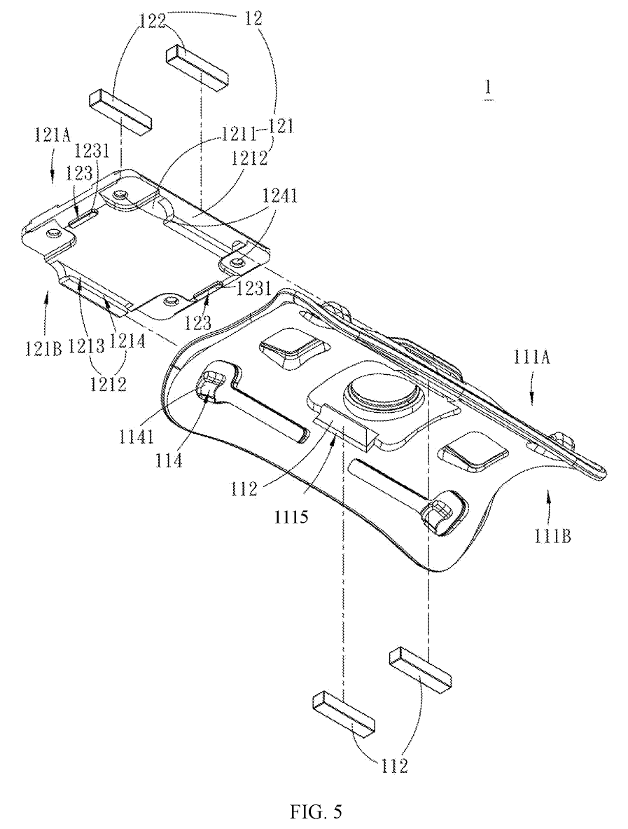

Please refer to FIGS. 1 to 5. FIG. 1 is the schematic structural diagram of a wearable structure in one embodiment of the present disclosure, FIG. 2 depicts another schematic structural diagram of the wearable structure in one embodiment of the present disclosure, FIG. 3 is the stereoscopic cross-section diagram of the A-A’ line of FIG. 1, FIG. 4 is the schematic exploded diagram of the wearable structure in one embodiment of the present disclosure and FIG. 5 is another schematic exploded diagram of the wearable structure in one embodiment of the present disclosure. As shown in figures, the present disclosure provides a wearable structure, and the wearable structure includes a first module 11 and a second module 12. The first module 11 is provided with a first body 111 and two first magnetic components 112, and the first body 111 is provided with a seat part 1111 and two groove parts 1112. The two groove parts 1112 are respectively located on the two opposite sides of the seat part 1111, and the two first magnetic components 112 are respectively disposed on the two opposite sides of the seat part 1111. The second module 12 is provided with a second body 121 and two second magnetic components 122, and the second body 121 is provided with a body part 1211 and two hook parts 1212. The two hook parts 1212 are respectively located on the two opposite sides of the body part 1211, and the two second magnetic components 122 are respectively disposed on the two opposite sides of the body part 1211. The body part 1211 of the second body 121 is mounted on the seat part 1111 of the first body 111, and the two hook parts 1212 of the second body 121 are respectively embedded in the two groove parts 1112 of the first body 111. At present, the two first magnetic components 112 and the two second magnetic components 122 attract each other.

In the present embodiment, the first body 111 is provided with a first top surface 111A and a first bottom surface 111B opposite to the first top surface 111A, the second body 121 is provided with a second top surface 121A and a second bottom surface 121B opposite to the second top surface 121A, and the second bottom surface 121B of the second body 121 is correspondingly mounted on the first top surface 111A of the first body 111. The two groove parts 1112 are respectively located on the two opposite sides of the seat part 1111, and each of the two groove parts 1112 is provided with a groove 1113 and a stable indentation 1114. The opening of the groove 1113 faces the outer surface of the seat part 1111 of the first body 111, and the groove 1113 horizontally extends along the two opposite sides of the seat part 1111. The stable indentation 1114 is located on the groove wall of the groove 1113 and is adjacent to one side of the first bottom surface 111B of the first body 111. The stable indentation 1114 and the groove 1113 are connected to each other.

According to the aforementioned descriptions, the two hook parts 1212 of the first body 111 extends from the two opposite sides of the second bottom surface 121B in a direction far away from the second top surface 121A, and one end of each of the two hook parts 1212 bends toward the interior of the corresponding groove part 1112. Each hook part 1212 further includes an extension body 1213 and a hook block 1214, and the extension body 1213 and the hook block 1214 are connected to each other. The extension body 1213 extends from the second bottom surface 121B to one side of the groove 1113 of the corresponding groove part 1112 in the direction far away from the second top surface 121A, the hook block 1214 extends to and enters into the opening of the groove 1113, and the hook block 1214 lies within the groove 1113. Still further, the hook block 1214 is embedded in the stable indentation 1114 of one side of the groove 1113.

In addition, the first bottom surface 111B of the first body 111 is provided with two first recesses 1115, the two first recesses 1115 are located on the two opposite sides of the seat part 1111, and the two first magnetic components 112 are embedded in the two first recesses 1115. The second top surface 121A of the second body 121 is provided with two second recesses 1215, the two second magnetic components 122 are respectively embedded in the two second recesses 1215, and the positions of the two second recesses 1215 and the positions of the two first recesses 1115 correspond to each other. Thus, the first body 111 is fixed to the second body 121 by the two first magnetic components 112 and the two second magnetic components 122.

In the present embodiment, the first top surface 111A of the first body 111 has at least one first fixing structure 113, and the second bottom surface 121B of the second body 121 has at least one second fixing structure 123. In other words, the at least one first fixing structure 113 is located the surface (i.e., the first top surface 111A) of the first body 111 in a mounting direction to mount the second body 121, and the at least one second fixing structure 123 is located on the surface (i.e., the second bottom surface 121B) of the second body 121 in a mounting direction to mount the first body 111. When the second body 121 is mounted on the first body 111, the at least one first fixing structure 113 and the at least one second fixing structure 123 are fixedly connected to each other. The at least one first fixing structure 113 is provided in two, and the two first fixing structures 113 are respectively located on the two opposite sides of the seat part 1111. The at least one second fixing structure 123 is provided in two, and the two second fixing structures 123 are respectively located on the two opposite sides of the body part 1211. The two second fixing structures 123 respectively correspond to the two first fixing structures 113. The first fixing structure 113 is a recess 1131, and the second fixing structure 123 is a protrusion 1231, and the protrusion 1231 is embedded in the recess 1131.

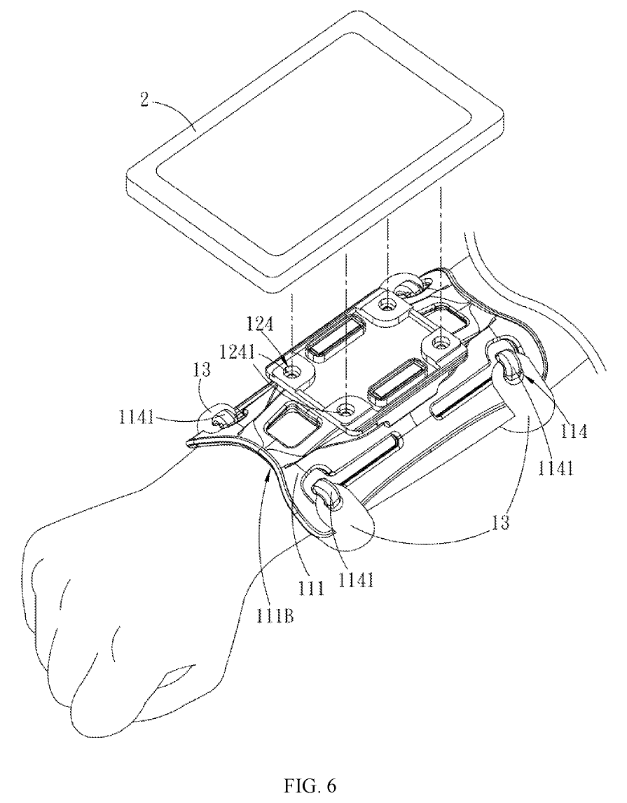

Please refer to FIG. 6, which is the example of the use state diagram of the wearable structure in one embodiment of the present disclosure. As shown in figures, in the present embodiment, there is still a mounting structure 124 on the second top surface 121 of the second body 12; in other words, the mounting structure 124 is disposed on the body part 1211. The mounting structure 124 is configured to mount and fix an electronic device 2. In the present embodiment, the mounting structure 124 includes four stable through holes 1241, and the four stable through holes 1241 are respectively located on the four corners of the second body 121. The electronic device 2 is fixed to the second top surface 121A of the second body 121 by the stable through holes 1241. In another embodiment, the mounting structure includes four permanent magnets which are located on the second top surface 121 of the second body 12. The four permanent magnets are respectively located on the four corners of the second body 121, and the electronic device 2 is fixed to the second top surface 121A of the second body 121 by the magnetic attraction of the permanent magnets. In addition, the wearable structure 1 further includes a connecting component 13, there is a connecting structure 114 on the outer side of the first body 111, and the two ends of the connecting component 13 are respectively connected to and fixed to the connecting structure 114. The first bottom surface 111B of the first body 111 is an accommodation surface structure with a radian, and the connecting structure 114 has four anchors 1141 which are respectively located on the four corners of the first body 111. The connecting component 13 may be a fixed strap. Thus, the two ends of the connecting component 13 may be twisted and fixed on the connecting structure 114.

In the present embodiment, a user fixes the electronic device 2 to the second module 12 first and mount the second module 12 on the first module 11. The second bottom surface 121B of the second body 121 corresponds to the first top surface 111A of the first body 111, the second bottom surface 121B of the second body 121 and the first top surface 111A of the first body 111 remain parallel to each other, and the second body 121 is horizontally mounted on the first body 111. The hook block 1214 of the hook part 1212 of the second body 121 enters along the extension direction of the groove 1113 of the groove part 1112 of the first body 111 so that the hook block 1214 of the hook part 1212 lies within the groove 1113; thus, the vertical direction of the hook block 1214 is restrained by the groove wall of the groove 1113 to limit the vertical movements of the second body 121 relative to the first body 111.

Still further, the hook block 1214 of the hook part 1212 corresponds to the stable indentation 1114 on the groove wall of one side of the groove 1113 and is vertically embedded in the stable indentation 1114. Thus, the horizontal direction of the hook block 1214 is restrained by the stable indentation 1114 to limit the horizontal movements of the second body 121 relative to the first body 111. At present, the second bottom surface 121B of the second body 121 is attached to the first top surface 111A of the first body 111, the two first magnetic components 112 of the first body 111 and the two second magnetic components 122 of the second body 121 attract each other, and the fixed relationship between the first body 111 and the second body 121 is thus reinforced. Moreover, the protrusion 1231 of the second fixing structure 123 is embedded in the recess 1131 of the first fixing structure 113, and the horizontal movements of the second body 121 and the first body 111 are thus restrained.

In the present embodiment, the first module 11 is mounted on the arm of the user so that the first bottom surface 111B of the first body 111 can approach the radian of the arm to fit and cover the arm. The two ends of the connecting component 13 are twisted on the connecting structure 114, and the connecting component 13 and first body 111 encompasses the arm circumference of the user; thus, the first module 11 is twisted and fixed on the arm of the user by the connecting component 13.

In view of the above descriptions, the wearable structure provided by the present disclosure may facilitate the handheld electronic device to be worn on the arm of the user by the mounting way of the first module and the second module, and the requirements of using the handheld electronic device may be thus avoided. The handheld electronic device may be mounted on the second module, the first module is worn on the arm of the user, and the second module may be mounted on the first module. Thus, the handheld electronic device on the second module is worn on the arm of the user by the first module, the mounting and the dismantling of the second module relative to the first module may be all completed by the single hand of the user to improve the convenience of using the wearable structure by the user.

Although the present disclosure has described and demonstrated numerous preferred embodiments, as described above, it should be appreciated that the present disclosure may not be limited to the form disclosed herein and may be applied to various other combinations, modifications and environments instead of being regarded as the exclusion of the other embodiments, and the present disclosure can be altered or modified by the above teaching or the related technologies or knowledge in the scope built by the present disclosure. The modifications and the variations made by a person skilled in the art without departing from the spirit of the present disclosure should be considered within the scope of the protection of the present disclosure as limited solely by the appended claims.

What is claimed is:

1. A wearable structure comprising:
a first module provided with a first body and two first magnetic components, wherein the first body is provided with a seat part and two groove parts, the two groove parts are respectively located on two opposite sides of the seat part, and the two first magnetic components are respectively disposed on the two opposite sides of the seat part; and
a second module provided with a second body and two second magnetic components, wherein the second body is provided with a body part and two hook parts, the two hook parts are respectively located on two opposite sides of the body part, and the two second magnetic components are respectively disposed on the two opposite sides of the body part;
wherein the body part of the second body is mounted on the seat part of the first body, the two hook parts of the second body are embedded in the two groove parts of the first body, and the two first magnetic components and the two second magnetic components attract each other.

2. The wearable structure according to claim 1, wherein the first body is provided with a first top surface and a first bottom surface opposite to the first top surface, the second body is provided with a second top surface and a second bottom surface opposite to the second top surface, and the second bottom surface of the second body is correspondingly mounted on the first top surface of the first body.

3. The wearable structure according to claim 2, wherein the projection of the two first magnetic components on the second top surface overlaps the projection of the two second magnetic components on the second top surface.

4. The wearable structure according to claim 2, wherein the two hook parts extend from two opposite sides of the second bottom surface in a direction far away from the second top surface, and one end of each of the two hook parts bends toward an interior of the corresponding groove part.

5. The wearable structure according to claim 4, wherein each of the two groove parts is provided with a groove and a stable indentation located on an inner side of the groove, and the stable indentation and the groove are connected to each other.

6. The wearable structure according to claim 5, wherein each of the two hook parts further includes an extension body and a hook block which are connected to each other, the extension body extends from the second bottom surface to the corresponding groove part in the direction far away from the second top surface, and the hook block extends in a direction toward the corresponding groove part and is embedded in the stable indentation.

7. The wearable structure according to claim 2, wherein the first bottom surface of the first body is provided with two first recesses located on the two opposite sides of the seat part, and the two first magnetic components are respectively embedded in the two first recesses; the second top surface of the second body is provided with two second recesses, the two second magnetic components are respectively embedded in the two second recesses, and positions of the two second recesses and positions of the two first recesses correspond to each other.

8. The wearable structure according to claim 2, wherein the first top surface of the first body has at least one first fixing structure, the second bottom surface of the second body has at least one second fixing structure, and the at least one first fixing structure and the at least one second fixing structure are fixedly connected to each other.

9. The wearable structure according to claim 8, wherein the at least one first fixing structure is provided in two, and the two first fixing structures are located on the two opposite sides of the seat part; the at least one second fixing structure is provided in two, and the two second fixing structures are located on the two opposite sides of the body part and respectively correspond to the two first fixing structures.

10. The wearable structure according to claim 9, wherein the first fixing structure is a recess, and the second fixing structure is a protrusion embedded in the recess.

11. The wearable structure according to claim 1, wherein a second top surface of the second body is further provided with a mounting structure, and the mounting structure is configured to mount and fix an electronic device.

12. The wearable structure according to claim 1, further comprising a connecting component, and there is a connecting structure on an outer side of the first body, and the connecting component is fixedly connected to the connecting structure.

13. A wearable structure comprising:
a first module provided with a first body and two first magnetic components, wherein the first body is provided with a seat part and two groove parts, the two groove parts are respectively located on two opposite sides of the seat part, and the two first magnetic components are respectively disposed on the two opposite sides of the seat part;
a second module provided with a second body and two second magnetic components, wherein the second body is provided with a body part and two hook parts, the two hook parts are respectively located on two opposite sides of the body part, and the two second magnetic components are respectively disposed on the two opposite sides of the body part; and
a mounting structure disposed on the body part and configured to mount and fix an electronic device, wherein the mounting structure and the two hook parts are separate from one another;
wherein the body part of the second body is mounted on the seat part of the first body, the two hook parts of the second body are embedded in the two groove parts of the first body, and the two first magnetic components and the two second magnetic components attract each other.

14. The wearable structure according to claim 13, wherein the first body is provided with a first top surface and a first bottom surface opposite to the first top surface, the second body is provided with a second top surface and a second bottom surface opposite to the second top surface, and the second bottom surface of the second body is correspondingly mounted on the first top surface of the first body.

15. The wearable structure according to claim 14, wherein the mounting structure comprises a plurality of stable through holes which are located on the second top surface of the second body.

16. The wearable structure according to claim 14, wherein the mounting structure comprises a plurality of permanent magnets which are located on the second top surface of the second body.
